(19) United States
(12) Patent Application Publication
(10) Pub. No.: US 2009/0008921 A1
(43) Pub. Date: Jan. 8, 2009

(54) Picture lamella card

(76) Inventor: Mordeckai Mouyal, Tel Aviv (IL)

Correspondence Address: Laura Dagan, 149 Grand St., White Plains, NY, 10601, US

(21) Appl. No.: 11/825,326

(22) Filed: Jul. 6, 2007

(51) Int. Cl. B42D 15/00

(52) U.S. Cl. 283/56

(57) ABSTRACT

A picture lamella card exhibits an image carrier (32) which consists of an upper part (34) and a bottom part (36). The upper part (34) exhibits a sight-opening (38) for a picture (16) which is designated for the inside (42) of the bottom part (36). At least one lamella component (10, 12), which covers part of the picture (16) and which can be moved, is designated. Furthermore, a slide component (18), which in particular also covers part of the picture (16), is designated. The slide component (18) is connected with the lamella component (10, 12) through a slide and take-along mechanism (26, 30, 64, 66). Furthermore a clamp component (44) for the purpose of a gripping retention of the lamella component (10, 12) during a movement of the slide component (18) by a first partial distance is designated. During a subsequent additional sliding over a second partial distance the release of the lamella component (10, 12) through the clamp component (44) occurs.

The invention concerns a picture lamella card.

Picture lamella cards are used as gift and greeting cards and especially for advertising campaigns such as mailings, etc. picture lamella cards provide of an upper and bottom part which are folded in analogy to an envelop or similar, so that a gap is formed in which lamellas are being aligned. By means of a slide component which is connected with the lamella components or a lamella component which is formed as a slide component the individual lamella components can be slid via a complex slide and take-along mechanism. Thus a picture being displayed by the lamella components is modified or an existing picture that is hidden under several of all lamella components is revealed. Current picture lamella cards exhibit the disadvantage that especially the slide and take-along mechanism turns out as too complex and thus expensive. As a result such picture lamella cards—despite their conspicuity and hence their eligibility for ad campaigns—are often not deployed for such kind of actions.

The goal of the invention is to create a simply constructed graphic lamella card which can be produced in a cost-effective manner.

According to the present invention the answer to the task results from the characteristics of claim 1.

The picture lamella card according to the present invention exhibits an upper and bottom part. These are preferably manufactured of one piece, especially of a carton and/or a thick foil. The upper and bottom part form a picture carrier and are aligned opposite to each other, whereby there is a sight-opening—that resembles a cut-out—designated in the upper part. On the inside of the bottom part there a picture is arranged in such a manner that the sight-opening is visible. The picture can e.g. be about a graphic, a slogan, etc. Between the upper and bottom, i.e., in the slit or pocket that formed between the parts, at least one lamella component is arranged that can be slid herein. The lamella component covers part of the pictures that is designated for the inside of the picture's bottom part. The width of the lamella component e.g. corresponds with one third of the width of the picture. Furthermore there is a slide component arranged in the gap, i.e. the gap between upper and bottom part. The slide component is connected with the at least one lamella component by a slide and take-along mechanism.

Preferably the slide component is devised such that it itself forms a lamella component and covers part of the picture and is movable for the purpose of revealing the picture.

According to the present invention the picture lamella card provides of a clamp component. By means of the clamp component at least one lamella component is kept in a clamped state during part of the sliding procedure. E.g. the slide component, that at the same time serves as a lamella component, is being moved by a first partial distance, whereby the lamella component is kept in the concerning position by means of the clamp element during this sliding procedure. Hereby a movement of the slide component, that also serves as lamella component, by the partial distance that is covered by the picture of the slide component, particularly occurs. With another movement of the slide component a take-along of the lamella component and a simultaneous release of the lamella component by the clamp component occur due to the existing slide and take-along mechanism. After the release of the lamella component through the clamp component another movement of the clamp component by a partial distance occurs in particular together with the lamella component. Preferably at least one further lamella component is designated, which is also kept by means of the clamp component and that is released as soon as a movement is carried out.

Due to the interaction according to the present invention between the clamp component and the slide and take-along mechanism a simple physical form of the lamella card can be selected, whereby due to the movement of the slide component and the corresponding take-along of the at least one lamella component a release of the picture, that is located on the inside of the bottom part, occurs.

The clamp component is preferably arranged between the upper and bottom part of the picture carrier. Hereby the clamp component is shaped as a carton layer in particular preferred embodiment, whereby the clamping effect results from the friction between the at least one lamella component and the clamp component. Particularly the clamp component is shaped as the bottom or upper part's lug. As the case may be two adjoining lugs, that form the clamp component in order to generate friction, can also be designated. According to the present invention the lamella component is hereby preferably slid or inserted into the clamp component and is kept in a clamping state due to the generated friction. Since the clamp effect is a result of friction, the at least one lamella component can be pulled out of the clamp element. This e.g. is carried out by means of the take-along mechanism, which particularly subject to the position of the slide component takes-along the lamella component.

For the purpose of taking-along the lamella component the lamella component and/or the slide component exhibit a stop, which works together with the slide and take-along mechanism. Hereby the stop is arranged such that, after the movement of the slide component by a first partial distance, the slide component or the slide and take-along mechanism that is connected with the slide component takes along the lamella component.

In a particular preferred embodiment the slide and take-along mechanism exhibits a lug or a shoulder, respectively, that are connected with the slide component. The shoulder is guided in a longitudinal groove of the at least one lamella component. The longitudinal slit of the lamella component is preferably closed at least one site, so that the end of the longitudinal slit serves as a stop. As a matter of course the lug can also be arranged at the lamella component, whereby the slide component then exhibits a respective longitudinal slit. It particular preferred, to intend two lugs, which are—with respect to their opposite position—are aligned against the slide direction. It is particularly preferred to intend two lugs that are aligned with the slide direction with respect to their opposite position. Particular the lugs are arrange in a range externally with respect to the sight opening or the sight window of the upper part, so that these are not visible to the user.

With a preferred embodiment the clamp component is arranged in the range of an external edge or the outside of the picture lamella card, respectively, whereby the slide component e.g. can be pulled out of the slit at the narrow side of the picture lamella card. The slit is formed by the upper and bottom part. At the other narrow side of the picture lamella card the clamp component is also designated within the picture lamella card between upper and bottom part. In order to facilitate a clamp behavior with at least one lamella component, the lamella component exhibits a shoulder that is particularly extended in longitudinal direction and which points in direction of the clamp component or which is arranged within the clamp component during the gripping retention. As for several lamella components it is particularly preferred that several lamella components are held by a clamp component. In particular several lamella components are being held by a single clamp component.

Since in a preferred embodiment all lamella components exhibit at least one corresponding shoulder, it is possible with a preferred embodiment to design the longitudinal slits in these shoulders, in which the lug of the slide component engages in order to form the slide and take-along mechanism. Hereby each slit preferably exhibits a closed end so that the end forms the take-along stop. Particularly two shoulders, which also exhibit a longitudinal slit and which are inserted in one of the preferably two lugs, are arranged opposite to each other and are extended in longitudinal or slide direction. Through this canting is avoided.

By partially pulling the slide component out of the slit which is formed by upper and bottom part, a partial distance of the picture that is designated on the inside of the bottom part is released in a first method step. During this drawing process the at least one lamella component is particularly held by the clamp component particularly through the shoulder that extends in longitudinal direction. Preferably the at least one lug that is designated at the slide component guides the lamella component in a slit, whereby lug and longitudinal slit form the slide and take-along mechanism.

As soon as the first partial distance of the picture, which is arranged on the inside of the bottom part, is released, a take-along of the lamella component occurs through the slide and take-along mechanism. This can occur such that the at least one lug hits a shoulder which is designated at the lamella component, whereby the shoulder is particularly formed by the closed end of the longitudinal slit. Preferably two longitudinal slit, parallel to each other and whose end is closed at any one time, are designated, so that two stops are formed and canting is avoided. Through a joint movement of the slide component with the lamella component another partial distance of the picture will be revealed. If an additional lamella component is designated, then this will be held by the clamp component during the joint movement of the first lamella component together with the slide component. Due to the slide and take-along mechanism the second lamella component will be taken-away as soon as the first partial distance of the picture is released. For this the lug which is designated at the slide component or the same two lugs which are opposite to each other and which are preferably also arranged in a longitudinal slit of the additional or second lamella component, can be utilized. These longitudinal slits also exhibit a preferably closed end that serves as a stop for the lugs and thus serves the take-along of this lamella component during the partial pull-out of the slide component of the picture lamella card.

In the following the invention is illustrated in more detail on the basis of a preferred embodiment and in reference to the attached drawings.

Displaying:

FIG. 1: a schematic, perspective view of the slide component and of two lamella components in an unconnected state,

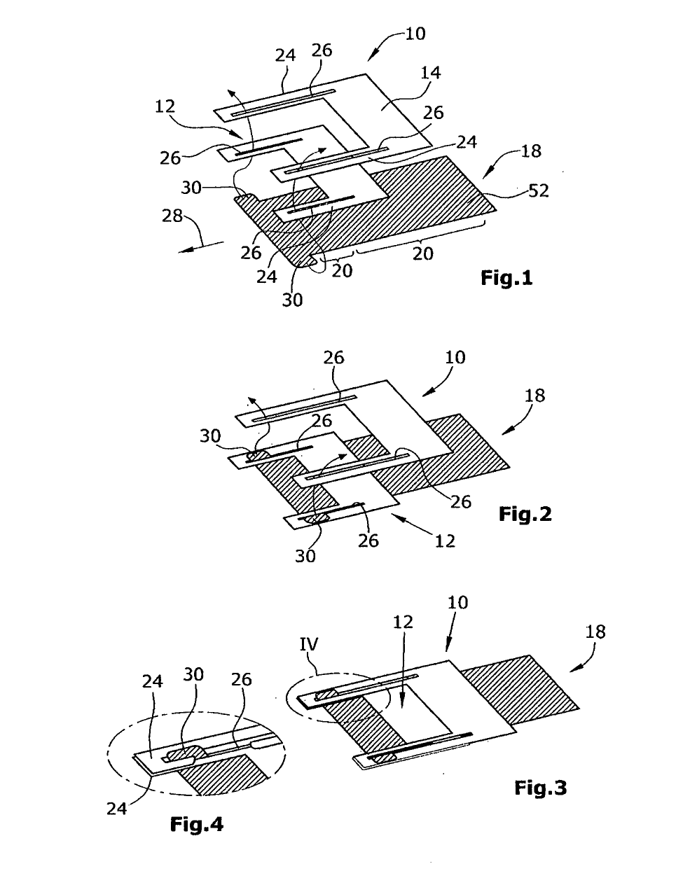

FIG. 2: the components according to FIG. 1, whereby the slide component and a first lamella component are connected with each other,

FIG. 3: the components according to FIG. 1, whereby the slide component and all two lamella components are connected with each other,

FIG. 4: a magnified view of area IV in FIG. 3,

FIG. 5: a schematic top view of the image carrier in an unfolded state,

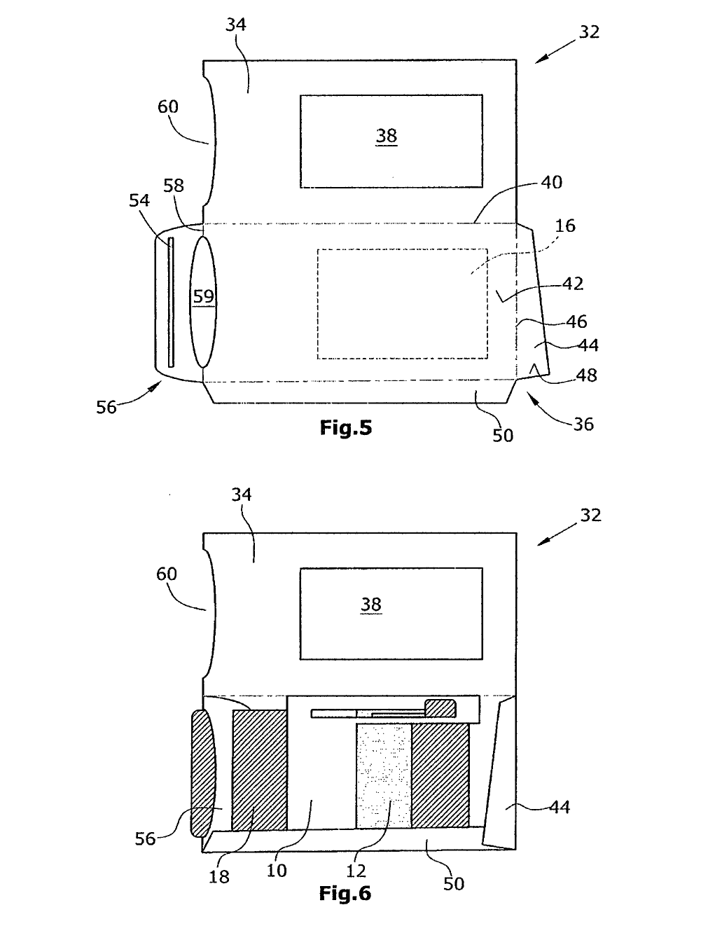

FIG. 6: a schematic view of the image carrier with inserted slide component and inserted lamella components, and

FIGS. 7 to 10: different positions of the slide components and the lamella components.

Each of the two lamella components 10, 12, exhibit a rectangular area 14, which covers part of the picture 16 (FIG. 9) of the picture lamella card in its assembled state. A slide component 18 also covers part of picture 16 through are 20 and in addition extends between the parts 14 of the lamella components 10, 12, and the picture 16. Hereby however, as for the concerning area 22 the slide component 18 does not need to exhibit the same width as in the depicted example, which corresponds with the height of picture 16, since these area of the picture are covered by the parts 14.

Lamella components 10, 12 both exhibit two shoulders 24 which extend in longitudinal direction 28. The shoulders 24 both exhibit a slit 26 which also extends in longitudinal direction 28.

In the depicted example slide component 18 exhibits two lugs 30, which are located opposite to each other and which are perpendicular to the longitudinal direction 28. The lugs 30 form the slide and take-along mechanism in conjunction with the longitudinal slits 26 of the lamella components 10, 12. For the purpose of assembly the lugs 30 are inserted in the longitudinal slits 26 of the lamella component 12 (FIG. 2). The same lugs 30 are then also inserted through the slits 26 of the lamella component. While being assembled the shoulders 24 of the two lamella components 10, 12 thus lay on top of each other, whereby the position of the lamella component 10, 12 and the slide component 18 and hence also the position of shoulder 24 changes with respect to each other during the sliding process.

The pre-assembled lamella components 10, 12 and the connecting component 18 which is connected with the pre-assembled lamella components 10, 12 is inserted into the image carrier 32 (FIG. 5, 6).

The image carrier exhibits an upper part 34 and a bottom part 36. As for the depicted example the upper part 34 exhibits a rectangular sight-opening 38 through which—when the image carrier 32 is closed—d the picture 16 is visible. In order to close the image carrier 32, the upper part 34 is bent around a buckling edge 40 until the upper part 34 and the bottom part 36 are arranged parallel to each other. Thus in its closed state the picture which is arranged on the inside 42 of the bottom part 36 or a concerning ad slogan 16 are visible. At first, however, picture 16 is covered by the slide component 18 and by the lamella components 10, 12 according to FIG. 6.

For the formation of the clamp component a lug 44, which is connected with the bottom part 36, is bent inwards, i.e. in direction of the inside 42, around a buckling edge 46, such that an inside 48 of the lug 44 is positioned opposite to the inside of the bottom part 36. Thus a narrow slit is formed, in which the shoulders 24 of the two lamella components 10, 12 can be inserted. Due to the respective designed dimensions a gripping fixation of the shoulder 24 takes place through the clamp component which is formed by lug 44 or through the slit between lug 44 and the bottom part 36.

In order to define the position of the lamella components 10, 12 and the slide component 18 (FIG. 6) a lower lug 50 is also folded inwards in direction of the inside 42.

A grip shoulder 52 (FIG. 1) of the slide component is inserted through a slit 54 (FIG. 5) of an additional lug 56, which is connected with the bottom part 36. At the same time the lug 56 is folded inwards around a buckling edge 58 (FIG. 6). The grip shoulder 52 is then arranged in a recess, which is formed by the gap 59 (FIG. 5). In order to avoid covering of the grip shoulder 52, the upper part 34 also depicts a recess 60.

In FIGS. 7 to 10 the function of the picture lamella card according to the present invention is schematically displayed, whereby the image carrier 32 is only adumbrated for the purpose of clarification. In order to operate the picture lamella card a user must pick the slide component 18 at the gripping device 52 and pulls it from the position which is depicted in FIG. 7 in direction of an arrow 62 in the position which is depicted in FIG. 8. Hereby the lugs 30 slide in the two slits 26 of the lamella components 10, 12 in direction of the arrow, i.e. in longitudinal direction of the card. Hereby the two lamella components 10, 12 are not yet being moved, since the ends of shoulders 24 are retained by the clamp component, i.e. by the lug 44 (FIG. 5). By pulling of the slide component 18 in direction of the arrow 62 the lugs 30 reach an end 64 of the slits 26 of the lamella component 12. Hereby the ends 64 serve as stop or take-along. Through a further pulling of the slide component 18 in direction of the arrow 62 from the position as depicted in FIG. 8 to the position as depicted in FIG. 9 a take-along of the lamella component occurs, whereby the concerning shoulder 24 of the lamella component 12 is being pulled out of the clamp component 44. However, the shoulders 24 of the additional lamella component 10 continue to be retained by the clamp component 44 until the slide component 18 together with the lamella component 12 are transferred into the position depicted in FIG. 9. Thus in FIG. 9 the picture 16, which is designated on the inside 42 of the bottom part 36, is already two-thirds visible.

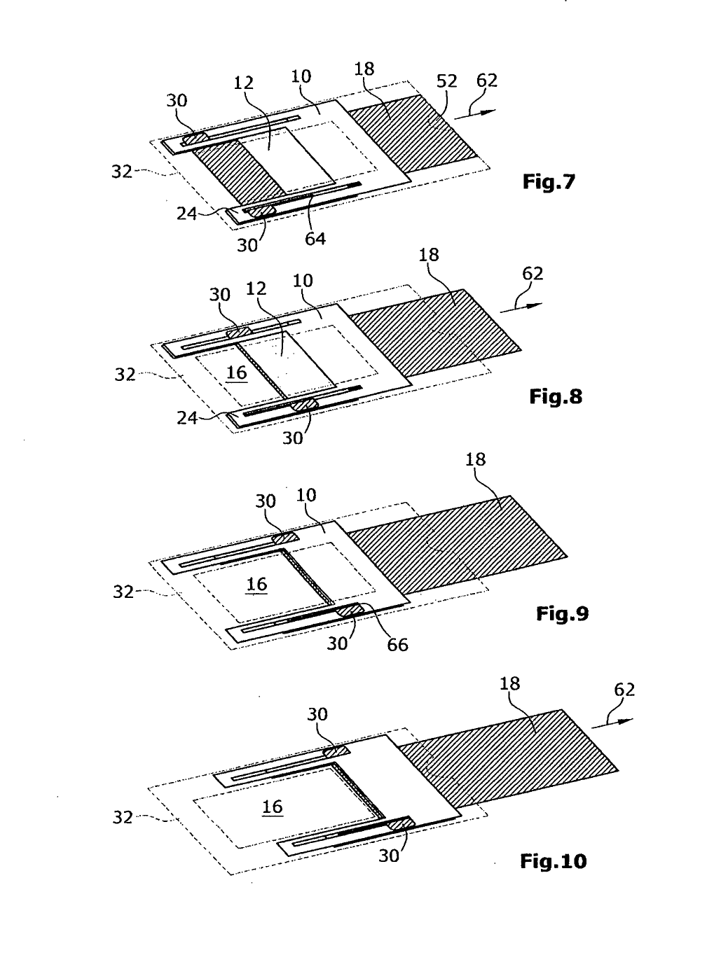

The slits 26 of the lamella component 10 also exhibit ends 66 (FIG. 9) which serve as a stop, where the lugs 30 can hit in the position depicted in FIG. 9. As for a further movement of the slide component 18 in direction of the arrow 62, this will cause the lamella component 10 also to move in direction of the arrow 62. That is the case until picture 16 is complete released according to FIG. 10.

The picture lamella card also transferred back from the position depicted in FIG. 10 into the position depicted in FIG. 7. For this the slide component is moved inwards from the position depicted in FIG. 10 in the opposite direction with respect to the arrow 62. Since the slits 26—they serve as additional stop units—are closed at both ends, there occurs a take-along of the respective lamella component 10 or 12, respectively during the insertion of the slide component 18, as soon as the lugs 30 have reached the corresponding slit ends. When arriving in the position as depicted in FIG. 7 the shoulders 24 are inserted again into the clamp component, so that the functional capability of the lamella card is restored.

1. Picture Lamella Card with
An imaging carrier (32) exhibiting an upper part (34) and a bottom part (36), whereby the upper part (34) exhibits a sight-opening (38) for a picture (16) that is designated for the inside (42) of the bottom part (36),
At least one movable lamella component (10, 12) that covers part of the picture (16),
A slide component (18) that is connected with the lamella component (10, 12) by means of a slide and take-along mechanism (26, 30, 64, 66).
A clamp component (44) for the purpose of gripping retention of the lamella component (10, 12) during a movement of the slide component (18) by a first partial distance and subsequent release of the lamella component (10, 12) during the movement by a further partial distance.

2. Picture lamella card according to claim 1, characterized in that the clamp component (44) is arranged between upper part (34) and bottom part (36) and preferably is connected with the upper part (34) or the bottom part (36) in one piece.

3. Picture lamella cards according to claim 1 or 2, characterized in that the lamella component (10, 12) exhibits a stop (64, 66), which works together with the slide and take-along mechanism (26, 30, 64, 66) such that after the movement of the ship component (18) by the first partial distance the slide component (18) takes along the lamella component (10, 12).

4. Picture lamella card according to one of the claims 1 to 3, characterized in that the slide and take-along mechanism (26, 30, 64, 66) exhibits a lug (30) which is connected with the slide component (18) and which is guided in a longitudinal slit (26) that is designated in the lamella component (10, 12).

5. Picture lamella card according to claim 3 or 4, characterized in that the stop (64, 66) is formed by an end of the longitudinal slit (26).

6. Picture lamella card according to one of the claims 1 to 5, characterized in that the lamella component (10, 12) exhibits at least one shoulder (24) which extends in slide direction (62) and in which preferably the longitudinal slit (26) is arranged.

7. Picture lamella card according to claim 6, characterized in that the shoulder (24) works together with the clamp component (44) and in particular can be inserted.

8. Picture lamella card according to claim 1 to 7, characterized by an additional lamella component (10, 12) which covers an additional part of the picture (16) and which is moveable.

9. Picture lamella card according to claim 8, characterized in that additional lamella components (10, 12) are connected with the slide and take-along mechanism (26, 30, 64, 66) for the purpose of sliding.

10. Picture lamella card according to claim 8 or 9, characterized in that the additional lamella component (10, 12) exhibits a shoulder (24) which in particular can be inserted and which works together with the clamp component (44).

11. Picture lamella card according to one of the claims 1 to 10, characterized in that the slide component (18) and the lamella components (10, 12) can completely be moved out of the sight-opening (38).
